(19) United States
(12) Patent Application Publication
(10) Pub. No.: US 2008/0049886 A1
(43) Pub. Date: Feb. 28, 2008

(54) Method and Device for Locking a Nuclear Fuel Assembly in Position in a Housing

(75) Inventors: Roger Lahille, Azas (FR); Laurent Stachetti, Venejan (FR); Olivier Bernard, Laudun (FR)

Correspondence Address: THELEN REID BROWN RAYSMAN & STEINER LLP, P. O. BOX 640640, SAN JOSE, CA, 95164-0640, US

(73) Assignee: Cogema Logistics, Montigny Le Bretonneux (FR)

(21) Appl. No.: 10/539,282

(22) PCT Filed: Dec. 19, 2002
(86) PCT No.: PCT/FR02/04459

§ 371 Date: Jun. 16, 2005

(51) Int. Cl. G21C 19/19

(52) U.S. Cl. 376/261

(57) ABSTRACT

A method and device for blocking a fuel assembly in a housing of a transport basket. An attachment system is placed between an upper end piece of a fresh fuel assembly that it is to be transported and the open end of a housing in which the assembly is placed, to make a rigid connection between them. The attachment system holds the lower end piece of the assembly far from the bottom of the housing and puts the upper end piece in contact laterally with the corner of the housing designed to face downwards during subsequent transport of the assembly in the horizontal position. Furthermore, the lower end piece of the assembly is maintained laterally by a part of the housing with a smaller section.

### TECHNICAL DOMAIN

The invention relates to a method for blocking a nuclear fuel assembly in a housing designed to contain this assembly.

The invention also relates to a device designed to implement this blocking method.

Throughout the remainder of the text, the expression “fuel assembly” denotes a nuclear fuel assembly. This type of assembly is well known and includes a rigid frame supporting a tube bundle, each tube containing a stack of nuclear fuel pellets and being closed at its ends.

The invention is applicable particularly to transport of fresh fuel assemblies, in other words assemblies that have not been irradiated. It can be used for all types of fuel assemblies, and particularly for assemblies intended for use in pressurised water and boiling water nuclear reactors.

### STATE OF THE ART

Fresh fuel assemblies are usually transported between their manufacturing site and the nuclear reactor in which they will be used in transport packaging designed for this purpose.

Each transport packaging comprises a cavity in which a basket provided with one or several housings is placed. The shapes and dimensions of the housings are such that each housing can contain a single nuclear fuel assembly. The number of housings provided in a single basket depends on the size of the fuel assemblies that are to be transported.

The said assemblies have to be immobilised inside the packaging in order to guarantee the quality of fresh fuel assemblies on their arrival on the nuclear reactor site. This immobilisation is made firstly by clamping the basket in the cavity of the packaging, and secondly by blocking each of the fuel assemblies in its housing. The invention relates to how this function to block assemblies in their housings is achieved.

Document FR-A-2 773 415 proposes to block a fuel assembly with a square section inside its housing by placing adjustable clamping means on two of the adjacent faces of the housing, applying the assembly in contact with the two other faces of the housing. Adjustable clamping means are manoeuvred from the open end of the housing. They may be fully mechanical or they may include gas rams.

The blocking devices described in this document perform their function satisfactorily. However, they have the important disadvantages that they have a high mass, they are expensive to manufacture, and are large. The blocking devices are integrated into compartment walls, which significantly increases the thickness. Therefore the number of compartments contained in a single packaging is reduced by the presence of these devices. Consequently, the transport capacity of packages is limited, such that the number of transport operations to be made for a single reloading of the core of a nuclear reactor is increased. This increases the global price of delivery.

Documents FR-A-2 758 646, FR-A-2 760 562 and FR-A-2 765 721 propose solutions similar to those described in document FR-A-2 773 415. These solutions all have the same disadvantages of weight, dimensions and cost.

Furthermore, documents FR-A-2 674 667, FR-A-2 674 668 and FR-A-2 774 800 propose to clamp an assembly in its housing by making two adjacent sides of the housing on an articulated part of the packaging and placing clamping means on this articulated part.

This arrangement has even greater disadvantages than the previous arrangements, since it makes it impossible to transport more than two fuel assemblies at the same time.

### PRESENTATION OF THE INVENTION

In particular, the purpose of the invention is a device designed to block a fuel assembly inside a housing using simple and inexpensive means with minimum dimensions in the direction of the thickness of the housing walls, such that an increased number of assemblies can be transported at the same time.

This result is obtained according to the invention by means of a device for blocking a fuel assembly in a housing, the assembly comprising an upper end piece and the housing comprising a first open end and a second end, the device being characterised in that it comprises means of making a rigid connection between the upper end piece of the fuel assembly and the open end of the housing, in a predetermined relative position such that the assembly bears in contact with at least one face of the housing over at least part of its length, the said means capable of making a rigid connection being placed above the upper end piece of the assembly.

Since the fuel assembly is blocked by a device that connects the upper end piece of the assembly to the open end of the housing, this device may be placed in the housing above the assembly. Consequently, the thickness of the walls separating the adjacent housings can be minimised. Therefore, with a minimum size of the packaging, a larger number of assemblies can be transported than with blocking devices according to prior art. Furthermore, the mass and manufacturing cost of the device according to the invention are lower than in prior art.

The fuel assembly and the housing usually have polygonal sections, most frequently square. The predetermined position of the upper end piece of the fuel assembly relative to the open end of the housing is then such that the upper end piece bears in contact with the two adjacent faces of the housing.

Advantageously, the device is also designed so that a part of the section of the housing close to the bottom of the housing is smaller, the said part with a smaller section having dimensions approximately equal to the dimensions of a lower end piece of the fuel assembly, to assure that the lower end of the assembly can be well positioned.

Furthermore, the predetermined relative position defined by the means of making a rigid connection is such that the fuel assembly is suspended by the upper end piece and is not in contact with a shim placed in the second end of the housing.

Preferably, the means of making a rigid connection include a connecting device that can be fixed on the upper end piece of the assembly by first clamping means and can be fixed in the open end of the housing by second clamping means.

In this case, the connecting device advantageously includes transverse displacement means that can move the upper end piece of the assembly towards and away from the two adjacent faces of the housing, and axial displacement means capable of moving the assembly away from and towards the second end of the housing.

According to a first embodiment of the invention, the first clamping means, the second clamping means, the transverse displacement means and the axial displacement means are activated by separate control devices that can be manoeuvred separately.

In this case, the connecting device has a longitudinal axis that can be oriented parallel to a longitudinal axis of the fuel assembly. The first clamping means then preferably include jaws capable of moving onto a first part of the connecting device along approximately radial directions from the said axis. Furthermore, the second clamping means comprise a bayonet type ring capable of turning around a second part of the connecting device about the said axis. Furthermore, the axial displacement means comprise means of controlling a relative displacement between the first and second parts along the said axis and the transverse displacement means comprise at least one slide capable of moving on the first part of the connecting device along an approximately radial direction with respect to the said axis. The slide then also forms part of the second clamping means.

According to a second embodiment of the invention, the first clamping means, the second clamping means and the axial displacement means are activated by a single control device and the transverse displacement means are activated by another control device that can be manoeuvred separately from the single control device.

In this case, the single control device is advantageously a screw anchored free to rotate on the connecting device, the said screw acting on the thrust rods forming firstly the first clamping means and secondly the axial displacement means, and acting on jaws forming the second clamping means through control rods articulated on the connecting device, on a nut engaged on the screw, on thrust rods and on jaws, and the transverse displacement means include thrust pads anchored onto the connecting device.

According to a third embodiment of the invention, the first clamping means, the transverse displacement means and the axial displacement means are activated by a single control device. The second clamping means then include a separate attachment device.

In this case, the single control device is advantageously a screw, anchored free to rotate on the connecting device, the said screw acting on claws forming the first clamping means, the axial displacement means and the transverse displacement means, through a nut engaged on the screw and on which the said claws are articulated.

Another purpose of the invention is a method for blocking a fuel assembly in a housing, the assembly comprising an upper end piece, and the housing comprising a first open end and a second end, the method being characterised in that it consists of making a rigid connection between the upper end piece of the fuel assembly and the open end of the housing above the upper end piece of the assembly, in a predetermined relative position such that the fuel assembly is suspended by the upper end piece.

### BRIEF DESCRIPTION OF THE DRAWINGS

We will describe different preferred embodiments of the invention as illustrative and non-limitative examples, with reference to the attached drawings in which:

FIG. 1 is a vertical diagrammatic sectional view representing a fuel assembly kept inside a housing for a basket in a transport packaging using a blocking device according to the invention;

FIG. 2 is a diagrammatic top view of the assembly in FIG. 1, held in its housing by the blocking device according to the invention;

FIG. 3 is a vertical sectional view representing a blocked mode of a system for attachment of the upper end piece of a fuel assembly for a pressurised water nuclear reactor according to a first embodiment of the invention;

FIG. 4 is a sectional view comparable to FIG. 3, representing the attachment system when the fuel assembly is removed;

FIG. 5 is a sectional view comparable to FIGS. 3 and 4, representing the attachment system at the time that it is introduced into the upper end piece;

FIG. 6 is a top view of the attachment system in FIG. 3;

FIG. 7 is a sectional view along line VII-VII in FIG. 6;

FIG. 8 is a sectional view along line VIII-VIII in FIG. 6;

FIG. 9 is a vertical sectional view representing a blocked mode of an upper end piece attachment system of a fuel assembly for a boiling water nuclear reactor according to a second embodiment of the invention;

FIG. 10 is a vertical sectional view of the transverse displacement means fitted on the attachment system in FIG. 9, in a laterally loose mode;

FIG. 11 is a top view of the attachment system in FIG. 9;

FIG. 12 is a vertical sectional view of an attachment system for the upper end piece of a fuel assembly for a pressurised water nuclear reactor, illustrating a third embodiment of the invention;

FIG. 13 is a view comparable to FIG. 12 representing the attachment system when the claws of the said system grip the upper end piece of the assembly, and

FIG. 14 is a view comparable to FIGS. 12 and 13, representing the attachment system when the assembly is blocked in the high position and is offset laterally.

### DETAILED DESCRIPTION OF DIFFERENT PREFERRED EMBODIMENTS OF THE INVENTION

As shown diagrammatically in FIG. 1, when a fresh nuclear fuel assembly A has to be transported to the site of a nuclear reactor, it is placed inside a housing L provided for this purpose inside a basket designed so that it can itself be placed in a transport packaging.

One or several housings L may be formed in the same basket, without going outside the scope of the invention. Each housing L is sized to contain a single assembly A. Consequently, the inside dimensions of the housing L are slightly larger than the dimensions of the assembly A.

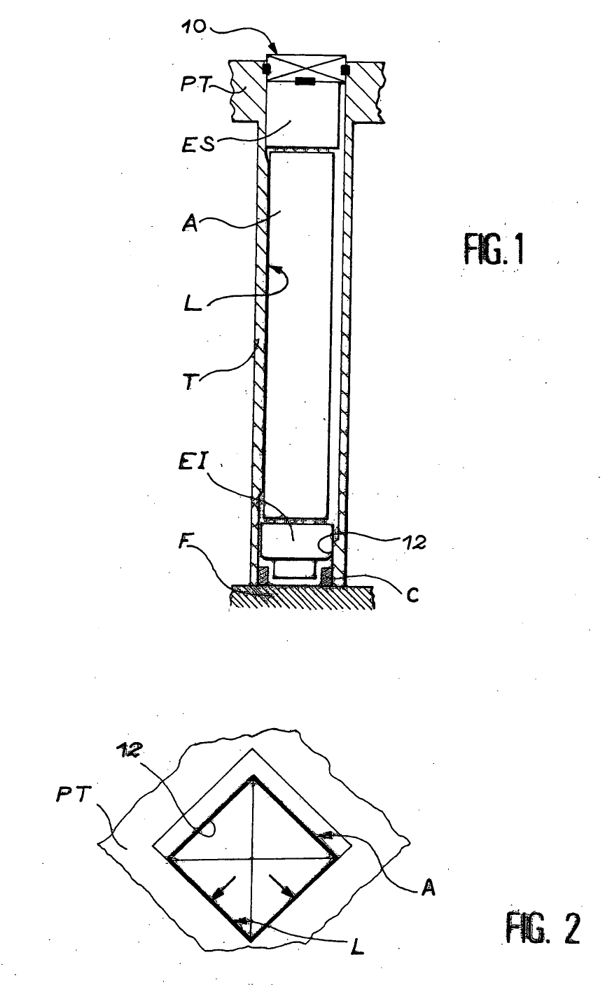

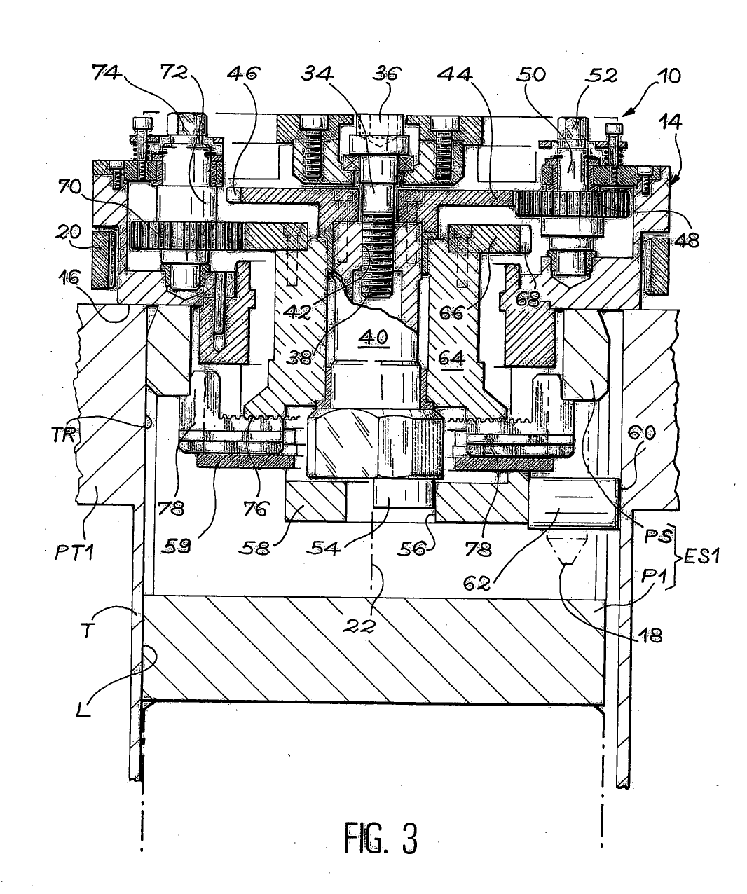

The assemblies A and the housings L are usually polygonal sections, usually square as shown diagrammatically in FIG. 2.

Regardless of the type of nuclear reactor in which they will be used, fuel assemblies A always comprise a rigid frame that supports a bundle of fuel rods. Each fuel rod comprises a tube closed at its ends and in which a stack of nuclear fuel pellets is located. In particular, the rigid frame comprises an upper end piece ES, a lower end piece EI and rods rigidly connecting these end pieces together. As will be seen in the following description, the upper end piece ES may have different shapes depending on the type of reactor in which the assembly will be used.

Furthermore, each housing L is delimited laterally by a tubular wall T with a section with exactly the same shape as assembly A. This shape is square in FIG. 2. When the housing L is oriented vertically as shown in FIG. 2, it is open at its upper end and is provided with a shim C at its bottom end. The bottom F of the packaging cavity in which the basket is placed closes off the bottom end of the housing L. The shim C is designed to support the assembly A axially at its lower end piece EI. The open end of the housing L is materialised by a support plate called the “head plate” PT fixed on the upper end of the tubular wall T.

When assemblies A are loaded and unloaded, the packaging is usually oriented such that the longitudinal axis of each housing L is approximately vertical. On the other hand, transport is done while the housings L are laid down approximately in the horizontal position. The assemblies A then bear in contact on the two adjacent lateral faces of the housing L facing downwards so as to form a V between them, as illustrated in FIG. 2.

Relative displacements between the assembly A and its transport packaging have to be limited, to guarantee quality of packagings transported to the reactor site. This is done by providing a first blocking device between each assembly A and its housing L, and a second blocking device is provided between the basket and the transport packaging. This second blocking device does not form part of the invention.

According to the invention and as shown diagrammatically in FIGS. 1 and 2, the device blocking the assembly A in its housing L comprises mainly an attachment system 10 designed to make a rigid connection between the upper end piece ES of the assembly A and the open end of the housing L materialised by the head plate PT.

More precisely, this rigid connection defines a predetermined relative position between the assembly A and its housing L. The relative position thus defined is such that the fuel assembly A is not in contact with the shim C provided in the bottom end of the housing L. Thus, a predetermined clearance is formed between the lower end piece EI of the assembly A and the shim C. This clearance enables the assembly to expand along its axis inside its housing without interfering with the housing. As a non-limitative example, the value of this clearance might be about 6 mm.

The attachment system 10 advantageously comprises axial displacement means capable of displacing the assembly to move it away from the bottom F of the housing L and towards the said bottom, to bring the assembly A into this predetermined relative position and vice versa.

In the preferred embodiments of the invention illustrated in the Figures, the attachment system 10 also comprises transverse displacement means arranged so as to displace the upper end piece ES of the assembly A towards the two adjacent lateral faces of the housing L designed to face downwards during transport of the packaging, and separating these two lateral faces. This displacement is made possible because there is a predetermined clearance in the transverse direction between the assembly A and the housing L, over most of the height of the housing. This clearance is necessary for the assembly to be correctly inserted into its housing during loading. The value of this transverse clearance is about 6 mm, as a non-limitative example.

In the preferred embodiments of the invention, the blocking device also comprises a part 12 of the housing L with a smaller section, close to the bottom of the housing. More precisely, this part 12 with a smaller section is located at the lower end piece EI of the assembly A and its dimensions are approximately equal to the dimensions of this end piece. Thus, the transverse displacement of the lower end piece EI of the assembly A is very much limited in the bottom part of the housing L.

The part 12 with a smaller section of the housing L is materialised by overhanging parts formed on the adjacent lateral faces of the housing L opposite the two adjacent lateral faces designed to face downwards during transport of the packaging.

Furthermore, the two faces of the housing L designed to face downwards when the assembly is in the horizontal position (as illustrated in FIG. 2) comprise setbacks in their top and bottom parts adjacent to the end pieces ES and EI. Consequently, considering the slight difference in section between the end pieces and the typical part of the assembly, the grids of the assembly come into contact with the two faces of the housing mentioned above, as shown in FIG. 1.

We will now describe a first embodiment of the invention with reference to FIGS. 3 to 8.

This first embodiment of the invention relates to an attachment system 10 designed to be inserted between the upper end piece ES1 of a fuel assembly A1 intended to be used in a pressurised water nuclear reactor and a head plate PT1 materialising the open end of a housing L1.

As shown in FIGS. 3 to 8, in this case the upper end piece ES1 comprises a solid lower plate Pi with a square section defining the section of the assembly. The upper end piece ES1 also comprises an upper plate PS located above and at a distance from the plate P1 when the assembly is oriented vertically. The central part of the upper plate PS is recessed and it is rigidly connected to the plate P1 by junction parts that cannot be seen in the Figures and are located at the four corners of the end piece ES1.

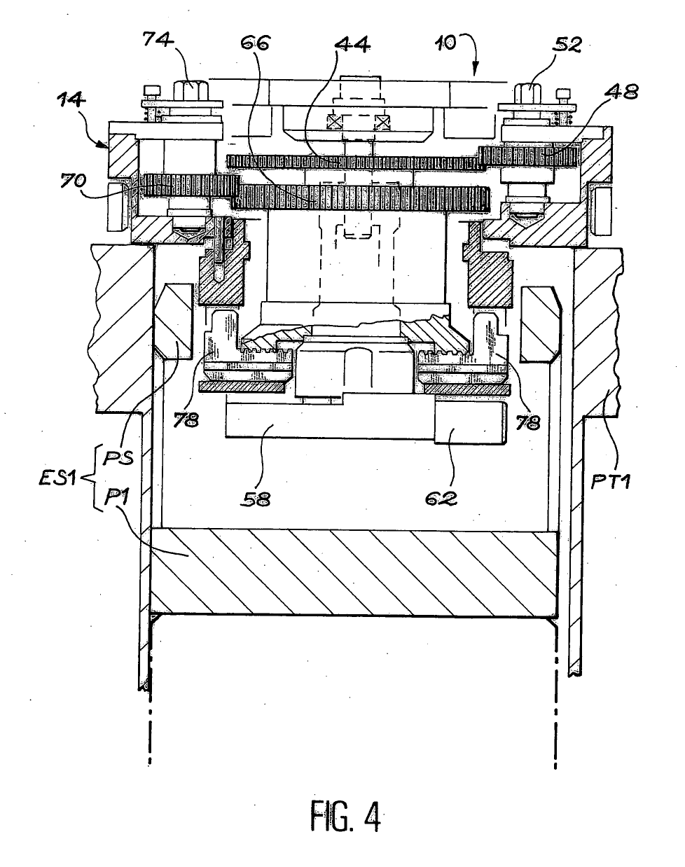

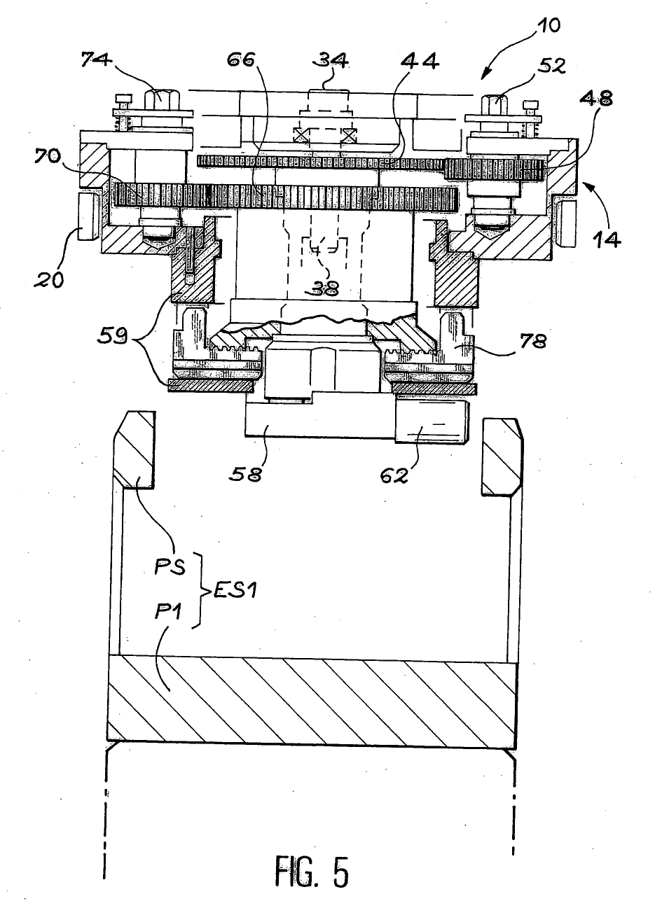

FIGS. 3 and 4 are more detailed and also show that in this case the housing L1 is formed inside a tube T with a square section, in which the open upper end is fixed, for example by welding, in a hole TR with the same section machined in the head plate PT1.

The attachment system 10 comprises a connecting device 14 that can come into place on the head plate PT1 so as to be centred on the hole TR formed in the head plate and on the recess in the upper plate PS of the upper end piece ES1 of the assembly.

The connecting device 14 comprises a plane support face 16 designed to face downwards when the assembly is oriented vertically. When the connecting device 14 is fixed on the head plate PT1 and on the upper end piece ES1 of the assembly A1, as illustrated in FIG. 3, the support face 16 bears on the upper face of the head plate and also on the upper face of the end piece.

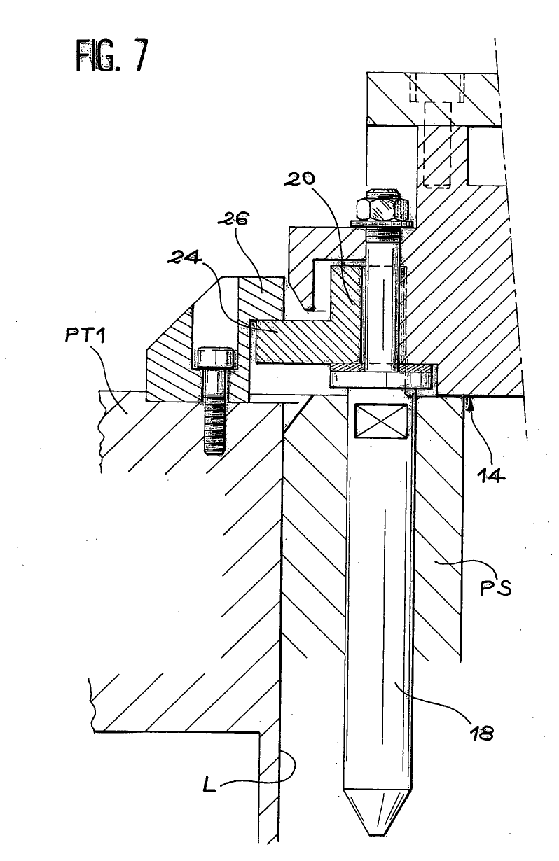

Two centring pins 18 project downwards from the support face 16. The centring pins 18 penetrate into holes formed in the upper plate PS of the upper end piece ES1, so as to centre the connecting device 14 on this end piece (see FIG. 7).

In the part located above the support face 16, the connecting device 14 supports a ring 20 on its external periphery capable of turning freely about a longitudinal axis 22 of the said device 14, oriented parallel to the axis of the housing L1 when the connecting device 14 is fixed on the housing.

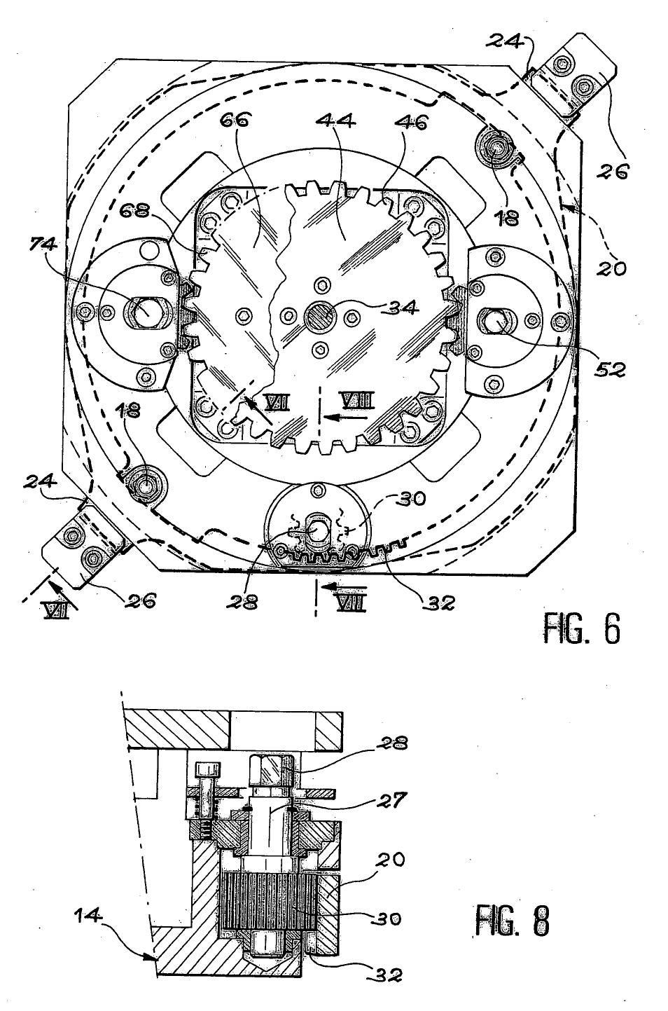

As shown particularly in FIGS. 6 and 7, the ring 20 is fitted with two lugs 24 on the outside. These two lugs 24 are located in diametrically opposite locations.

Furthermore, two flanges 26 are fixed, for example using screws, on the upper face of the head plate PT1, at locations diametrically opposite and on each side of the hole TR, on one of the diagonals of the square formed in section by this hole.

Depending on the angular position of the ring 20 about its axis 22, when the support face 16 of the connecting device 14 is supported on the top face of the head plate PT1, the lugs 24 can either engage with the flanges 26, in other words trapped between them and the upper face of the head plate PT1, or there is an angular offset between the lugs and the said flanges 26. In the first case, the connecting device is fixed to the head plate PT1. Otherwise, the connecting device is separated from the head plate. The arrangement thus made forms a rigid “bayonet” type link.

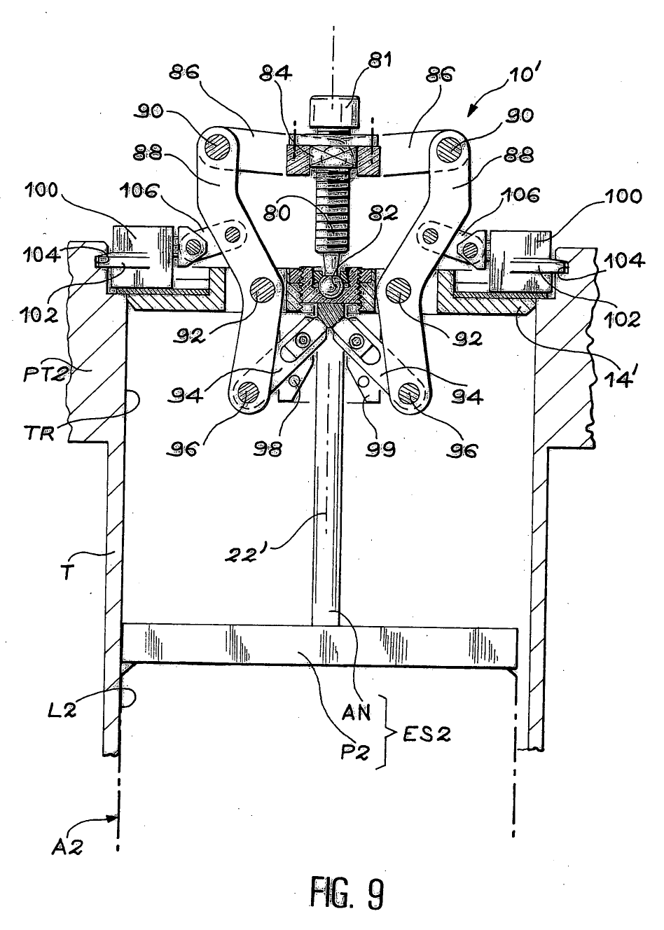

As can be seen in particular in FIG. 8, the connecting device 14 also supports a first control device 27, installed free to rotate about an axis parallel to the longitudinal axis 22. The first control device 27 is provided with a manoeuvring head 28 at its accessible end on the upper face of the connecting device 14. This makes it possible to control rotation of the first control device 27 using an appropriate tool.

The first control device 27 is fixed to a gear 30. This gear 30 is engaged on a toothed sector 32 provided for this purpose inside the ring 20.

The arrangement that has just been described fixes the connecting device 14 of the head plate PT or separates these two parts by controlling rotation of the first control device 27 in one direction or the other using an appropriate tool. The first control device 27, the ring 20 provided with its lugs 24 and the flanges 26 thus form means of making a rigid connection between the connecting device 14 and the open end of the housing L.

The upper central part of the connecting device 14 supports a second control device 34 arranged along its longitudinal axis 22 and capable of rotating about the said axis. The second control device 34 is provided with a manoeuvring head 36 at its accessible end on the upper face of the connecting device 14. This makes it possible to control rotation of the second control device 34 using an appropriate tool.

The second control device 34 at its opposite end comprises a thread 38. A cylindrical part 40 is engaged on this thread 38 by a female thread 42. At its top end, the cylindrical part 40 is fixed to a disk 44 centred on the longitudinal axis 22. There is a toothing 46 at the periphery of the disk 44. This toothing 46 is engaged on a gear 48 fixed to a third control device 50 supported by the connecting device 14.

Like the control devices 27 and 34, the third control device So is installed on an axis parallel to the longitudinal axis 22 and can rotate about the said axis. The third control device 50 is provided with a manoeuvring head 52 at its accessible end on the upper face of the connecting device 14. This makes it possible to control rotation of the third control device 50 using an appropriate tool.

The bottom end of the cylindrical part 40 is fixed to a pin 54, with an axis offset from the longitudinal axis 22. This pin 54 penetrates into a cam groove 56 machined in a sliding block 58. The sliding block 58 itself is mounted free to slide in a tubular part 59. The said tubular part is supported by a tubular part 64 mounted on the cylindrical part 40, such that the tubular part 59 can slide along the longitudinal axis 22, while being prevented from moving in rotation about this axis. The tubular part 59 projects downwards and inside the recess formed in the upper plate PS of the upper end piece ES1.

More precisely, the sliding block 58 is capable of displacing with respect to the tubular part 59 along a direction orthogonal to the longitudinal axis 22 and diagonally with respect to the square formed in section by the housing L1. Thus, the support surfaces 60 formed on the pads 62 fixed to the sliding block 58 can bear in contact with the adjacent faces of the housing L1 opposite to the faces that must be oriented downwards when the packaging is transported in the horizontal position.

With the arrangement that has just been described, it is possible to move the upper end piece ES1 of the assembly transversely towards the said faces designed to be oriented downwards, bearing on the opposite faces through pads 62, by activating the third control device 50. Thus, the control device 50, the cylindrical part 40 and the sliding block 58 form means of transverse displacement of the upper end piece ES1 of the assembly. This assembly also forms part of the second clamping means since it provides a means of clamping the connecting device 14 laterally in the open end of the housing L1.

The central part of the cylindrical part 40 supports the tubular part 64 coaxially. More precisely, the tubular part 64 is mounted on the cylindrical part 40, along the longitudinal axis 22 so that it can rotate freely about the said cylindrical part 40 while being connected to it along the direction of the longitudinal axis 22.

In its top part below the disk 44, the tubular part 64 is fixed to a disk 66, also centred on the longitudinal axis 22. The external periphery of the disk 66 is provided with a toothing 68. This toothing 68 is engaged on a gear 70 fixed to a fourth control device 72 supported by the connecting device 14.

Like the control devices 27, 34 and 50, the fourth control device 72 is mounted on an axis parallel to the longitudinal axis 22 and can rotate about the said axis. The fourth control device 72 is provided with a manoeuvring head 74 at its accessible end on the upper face of the connecting device 14. This makes it possible to control rotation of the fourth control device 72 using an appropriate tool.

The bottom end of the tubular part 64 is fixed to a plate on which a spiral toothing 76 is arranged on its face facing downwards. The said face is located in a plane perpendicular to the longitudinal axis 22.

Four jaws 78 are installed in the tubular part 59 so as to be able to slide parallel to the faces of the housing L1, towards the said faces and separate from them, in the said tubular part. Each of the jaws 78 has a spiral toothing on its upper face that engages onto the spiral toothing 76 supported by the tubular part 64.

Each of the jaws 78 in the top part of the face facing outwards, supports a V swivel joint (not illustrated) that can bear in contact with the lower inner corner of the recess formed in the upper plate PS of the upper end piece ES1 of the assembly.

With the arrangement that has just been described, it is possible to bring the four jaws 78 in bearing simultaneously against the lower inner corners of the recess formed in the upper plate PS, by activating the fourth control device 72. This assembly thus forms rigid connection means between the connecting device 14 and the upper end piece ES1 of the assembly.

The travel distances of the sliding block 58 and the jaws 78 are sufficient so that these parts can be retracted to enable the connecting device 14 to be inserted into the upper end piece ES through the recess formed in the upper plate PS, and so that the attachment system 10 can be put into place onto the upper end piece ES1 of the assembly but separate from it.

It can be understood that the joint manoeuvre of the two control devices 27 and 72 provides a means of making a rigid connection between the upper end piece of the assembly and the open end of the housing, through the connecting device 14 and the tubular part 59.

Finally, since the cylindrical part 40 is normally fixed in rotation by the third control device 50 engaged on the toothing 46 of the disk 44 through the gear 48, rotation of the second control device 34 has the effect of moving the cylindrical part 40 and the tubular parts 59 and 64 along the longitudinal axis 22. If the upper end piece ES1 of the fuel assembly is not blocked in contact with the lateral faces of the housing L1 by the sliding block 58, this arrangement provides a means of controlling limited displacement of the assembly along the longitudinal axis 22.

Thus, the second control device 34, the thread 38 and the female thread 42 form means of axially displacing the assembly.

Note that the heights of the toothings 46 and 68 of disks 44 and 66 that are free to move in the axial direction with parts 40 and 64, and the heights of the toothings of gears 48 and 70 that are fixed in the axial direction with respect to the connecting device 14, are determined such that these toothings remain continuously engaged.

In this first embodiment of the invention, the attachment system 10 is mounted on the upper end piece ES1 of the fuel assembly before it is inserted into its housing L1. Consequently, the sliding block 58 and the jaws 78 are firstly retracted into the connecting device 14 and the parts 40 and 64 are placed in a high position with respect to this connecting device. The ring 20 is also placed in the “unlocked” position.

The tubular part 59 and the connecting device 14 are inserted into the recess of the upper plate PS of the upper end piece ES1 until the support face 16 comes into contact with the upper face of this end piece. The fourth control device 72 is then activated so that the jaws 78 come into contact with the lower inner corners of the recess formed in the upper plate PS. The attachment system 10 is then rigidly fixed on the upper end piece ES1 of the assembly.

The assembly is then suspended from the attachment system 10, so that the assembly can be handled safely.

The attachment system 10 from which the assembly is suspended is then brought above the housing L1 and is gradually lowered. At the end of lowering, the lower end piece EI is positioned in the transverse direction by the part 12 with a reduced housing section (FIG. 1). Furthermore, when the support face 16 of the connecting device 14 bears in contact with the upper face of the head plate PT1, the lower end piece EI remains separated from the shim C and the bottom F of the cavity.

The operator then activates the third control device 50, so as to bring the pads 62 into bearing contact with the two faces of the housing L1 designed to face upwards during subsequent transport of the packaging (FIG. 2). The upper end piece ES1 is then brought into contact with the other two faces of the housing L1, designed to face downwards during transport. Therefore, the upper end piece ES1 is clamped transversely in the housing L.

The operator then activates the first control device 27 (FIG. 6) so as to fix the attachment system 10 onto the head plate PT1.

For each of the operations mentioned above, the operator preferably applies a predetermined tightening torque so as to embed the upper end piece ES1 into the housing L. This takes account of accelerations that could occur during normal transport conditions.

When transport is terminated, the operator activates the first control device 27, to separate the attachment system 10 from the head plate PT1.

The operator then activates the third control device 50 so as to retract the sliding block 58 and to eliminate the transverse clamping of the upper end piece ES1 in the housing L1.

The operator then activates the second control device 34 so as to put the assembly down in the bottom of its housing.

Finally, the operator activates the fourth control device 72 to separate the attachment system 10 from the upper end piece ES1. The attachment system 10 can then be put down as illustrated in FIG. 4, and the assembly unloaded from the transport packaging using tools used normally in nuclear power stations.

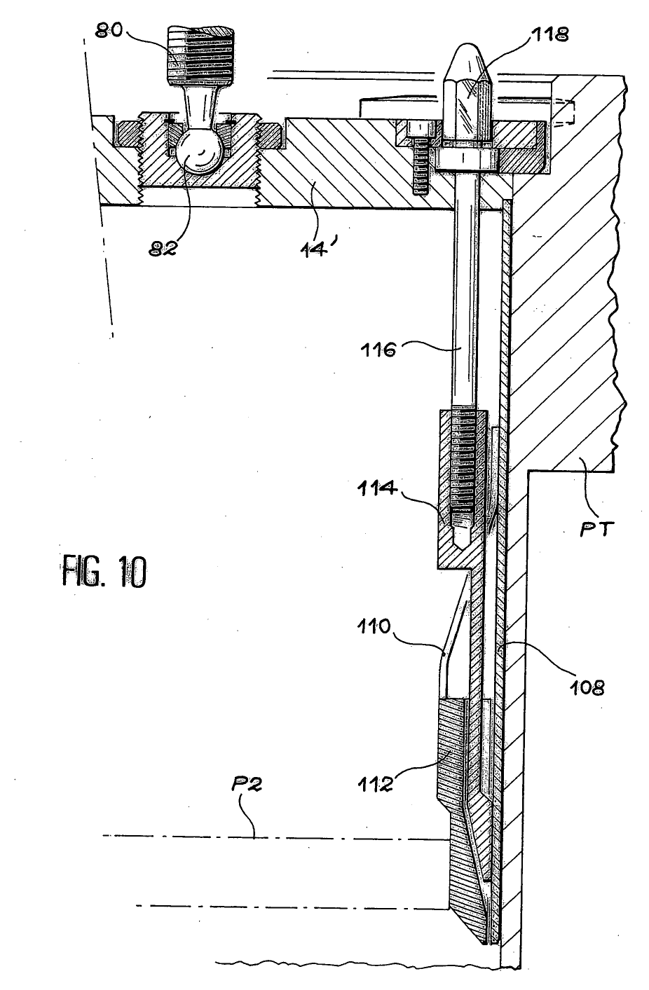

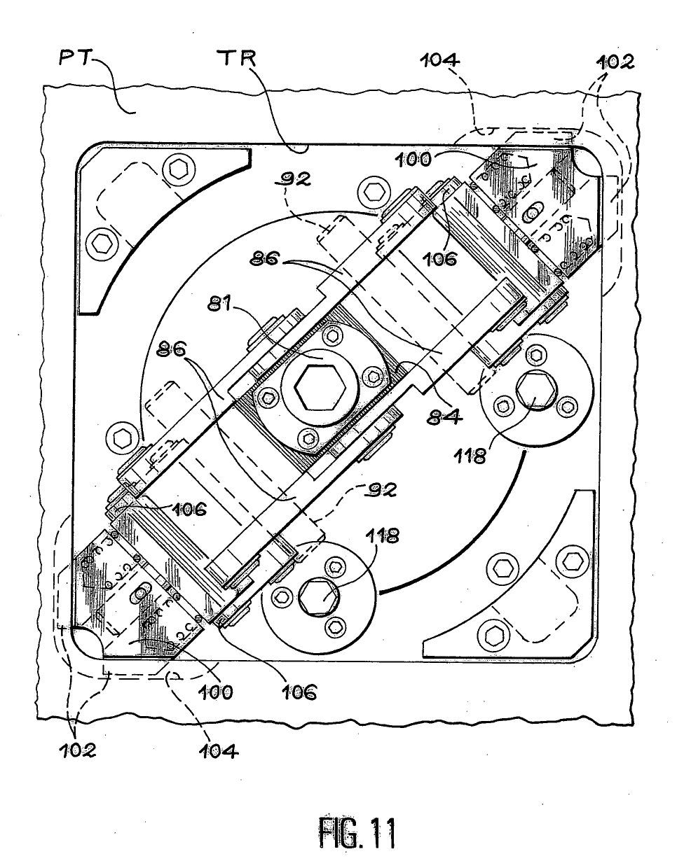

We will now describe a second embodiment of the invention with reference to FIGS. 9 to 11.

This second embodiment of the invention relates to an attachment system 10′ designed to be inserted between the upper end piece ES2 of a fuel assembly A2 designed for use in a boiling water nuclear reactor and a head plate PT2 materialising the open end of a housing L2.

As illustrated in FIGS. 9 to 11, the upper end piece ES2 of the assembly A2 in this case comprises a solid plate P2 forming a square in a top view, to which a handle AN is fixed forming an inverted U as seen in a side view. The handle AN is located in a plane passing through a diagonal of the square and through the longitudinal axis of the assembly.

As in the first embodiment, the housing L2 is delimited inside a tube T, in which the open upper end is welded in a hole TR machined in the head plate PT2.

In the embodiment shown in FIGS. 9 to 11, the attachment system 10′ comprises a connecting device 14′ that can be placed on the head plate PT2 so as to be centred on the hole TR formed in it and on the handle AN of the upper end piece ES2 of the assembly.

In this case, the connecting device 14′ is in the form of a square plate with dimensions approximately the same as the dimensions of the hole TR in which the plate is positioned.

A single control device materialised by a screw 80 is anchored at the centre of the connecting device 14′ so as to project upwards when the attachment system 10′ is placed on the housing L2 and when it is oriented vertically. More precisely, the screw 80 is articulated on the connecting device 14′ through a ball joint 82. The screw 80 is provided with a manoeuvring head 81 at its upper end so that it can be actuated using an appropriate tool.

A nut 84 is engaged on the screw 80. The first ends of the two rods 86 are articulated on the nut 84 through a common axis orthogonal to the axis of the screw 80. The opposite ends of each of the rods 86 are articulated on the first ends of two control rods 88 through axes 90 parallel to the articulation axis of the rods 86 on the nut 84.

Each of the control rods 88 is itself articulated on the connecting device 14′ through an axis 92 parallel to the axes 90. More precisely, the axes 92 are arranged to be symmetric on each side of the ball joint 82. The second end of each of the control rods 88 located below the connecting device 14′ is articulated to the end of a thrust rod 94 through an axis 96 parallel to the axes 90 and 92. The thrust rods 94 bear by gravity on thrust rods 98 fixed to the connecting device 14′. Their opposite ends can thus bear on the upper branch of the handle AN of the upper end piece ES2 as illustrated particularly in FIG. 7.

The rods 86, the control rods 88 and the thrust rods 94 are arranged in a plane passing through the longitudinal axis 22′ of the connecting device 14′ and through a diagonal of the square formed in a top view by the said device.

As will be better understood later, the thrust rods 94 thus form means of axially clamping the connecting device 14′ on the upper end piece ES2 of the assembly A2, and also means of axially displacing it parallel to the longitudinal axis 22′ of the connecting device 14′.

The connecting device 14′ supports two jaws 100 capable of sliding along the diagonal of the square that it forms in a top view. More precisely, the jaws 100 are located at the two opposite points of the square mentioned above. Each jaw comprises a projecting part 102 that can fit in a housing 104 provided for this purpose at the entrance to the hole TR formed in the head plate PT2. Two articulated rods 106 connect the jaws 100 to each of the control rods 88 at a location on these control rods between the axes 90 and 92. The jaws 100 thus form means of axially clamping the connecting device 14′ on the head plate PT materialising the open end of the housing L2.

A shock absorber element (not shown) is advantageously inserted between each rod 106 and the jaw 100 corresponding to it. This shock absorber element enables the jaws 100 to fulfil their clamping function regardless of the precise position in which the thrust rods 94 bring the upper branch of the handle AN to bear in contact with the lower face of the connecting device 14′.

As illustrated more precisely in FIG. 8, two rigid protection plates 108 project downwards, starting from two adjacent edges of the square plate forming the connecting device 14′. More precisely, the protection plates 108 are arranged along, the sides designed to face upwards during subsequent horizontal transport of the packaging. They extend downwards as far as the solid plate P2 of the upper end piece ES2 and the housing L2, when the attachment system 10′ is fixed in the top part of a housing L2 containing an assembly A2.

Each of the protection plates 108 carries a leaf spring 110 on its face designed to face inwards into the housing L2, the spring being fitted with a support element 112 at its lower end. A part of this support element 112 fits between the protection plate 108 and the adjacent edge of the solid plate P2, when the attachment system 10′ is inserted into the top part of a housing L2 containing an assembly A2. Due to the leaf spring 110, the support element 112 displaces the upper end piece of the assembly laterally.

The arrangement that has just been described enables an operator to move the upper end piece ES2 of the assembly A2 towards the two faces of the housing L2 intended to face downwards during subsequent transport of the assembly in its packaging in the horizontal position.

A wedge shaped thrust pad 114 is inserted between each protection plate 108 and the support element 112 corresponding to it. Each thrust pad 114 comprises a threaded hole in which a control screw 116 engages. This control screw is mounted on the connecting device 14′ so that it can rotate freely on the connecting device, while being connected to the said device parallel to its axis 22′. Each of the two control screws 116 comprises a manoeuvring head 118 accessible above the connecting device 14′, so that they can be activated by appropriate tools.

The thrust pads 114 thus form means of transverse clamping of the upper end piece ES2 of the assembly in its housing L2.

In the second embodiment of the invention illustrated in FIGS. 9 to 11, the attachment system 10′ is designed to be installed in the top of the housing L2 when the assembly A2 has already been inserted in it. Consequently, the lower end piece of the assembly is then supported on the shim C and on the bottom F of the cavity in the packaging.

The operator brings the attachment system 10′ above the assembly A2. The attachment system is then in its unlocked position, in other words the nut 84 is in its low position on the screw 80. Under these conditions, the ends of the thrust rods 94 are separated from the lower face of the plate forming the connecting device 14′ and are separated from each other by a distance greater than the width of the handle AN. Furthermore, the jaws 100 are retracted towards the centre of the connecting device 14′.

When the attachment system is put into place, the lower end of the protection plates 108 penetrates into the housing L2. The upper branch of the handle AN is automatically centred by an opening 99 located in the lower part of the connecting device 14′. The support elements 112 mounted on the leaf springs 110 simultaneously pre-position the upper end piece ES2 in contact with the corner of the housing that will face downwards when the packaging is being transported in the horizontal position. Precise centring of the attachment system 10′ on the housing is then achieved by embedding the connecting device 14′ on a complementary machining formed at the entrance to the hole TR in the head plate PT2. The final position of the system is obtained when the connecting device 14′ bears on the head plate PT2.

The operator then activates the screw 80 forming the single control device for the means of axially clamping the connecting device 14′ onto the head plate PT2, the means of axially clamping the connecting device on the upper end piece ES2 of the assembly, and the means of axial displacement of the assembly.

The ends of the thrust rods 94 thus fit under the upper branch of the handle AN and bring the said branch into contact with the lower face of the plate forming the connecting device 14′ as illustrated in FIG. 7. The upper end piece ES2 of the assembly A2 is then fixed to the connecting device 14′ and the lower end piece EI (FIG. 1) is separated from the shim C and the bottom F of the packaging. Simultaneously, the projecting parts 102 of the jaws 100 fit into the housings 104 of the head plate PT2, which has the effect of fixing it to the connecting device 14′.

The operator then activates the two control screws 116 so as to block the upper end piece ES2 laterally in contact with the corner of the housing L2 that will face downwards during subsequent transport of the packaging in the horizontal position.

On arrival at the nuclear reactor site on which the fuel assembly A2 will be used, the first step is for an operator to unscrew the two control screws 116 to release the clamping pressure applied to the bottom corner mentioned above.

The operator then activates the screw 80 so as to separate the assembly from the attachment system 10′ while keeping it suspended, to put the said assembly down in the bottom of its housing L2 and to separate the attachment system 10′ from the head plate PT2.

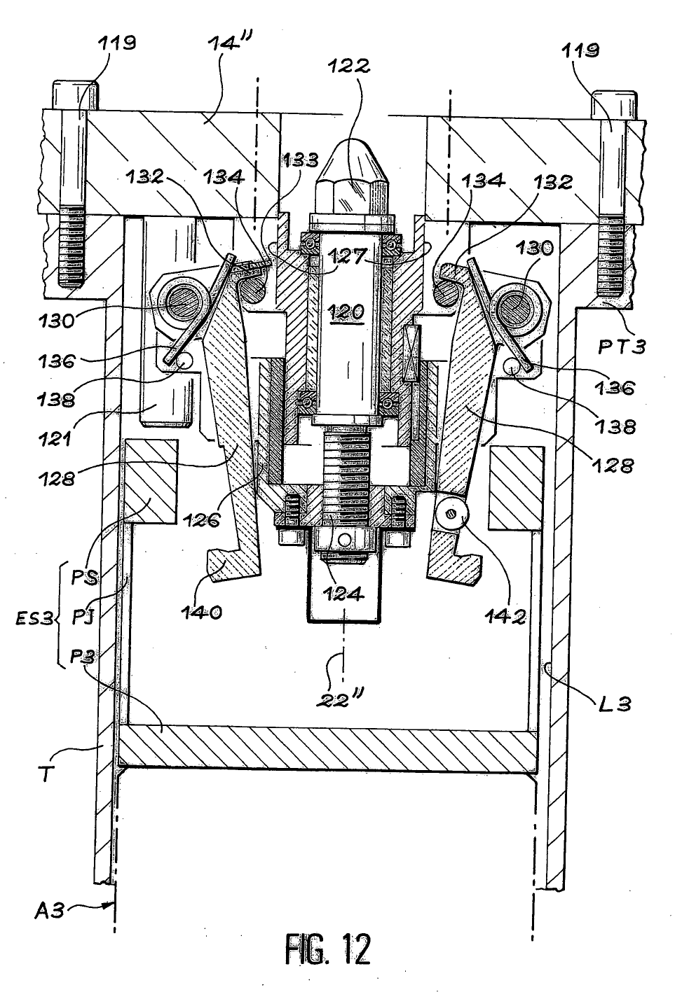

We will now describe a third embodiment of the invention with reference to FIGS. 12 to 14.

This third embodiment of the invention relates to an attachment system 10″ designed to be inserted between the upper end piece ES3 of a fuel assembly A3 intended to be installed in a pressurised water nuclear reactor and a head plate PT3 materialising the open end of a housing L3.

As illustrated in FIGS. 12 to 14, in this case the upper end piece ES3 of the assembly A3 comprises a solid lower plate P3, forming a square in a top view. The upper end piece ES3 also comprises an upper plate PS located above and at a distance from the solid plate P3 when the assembly is oriented vertically. The upper plate PS is hollowed out in its central part and is rigidly connected to the plate P3 by junction parts PJ located at the four corners of the end piece.

FIGS. 12 to 14 show a more detailed view in which the housing L3 is formed as above inside a tube T with a square section, in which the open upper end is fixed, for example by welding, into a hole TR with the same section machined in the head plate PT3.

The attachment system 10″ comprises a connecting device 14″ that is capable of fitting on the head plate PT3 so as to be centred on the hole TR formed in it using guide pins not shown.

Clamping means such as screws 119 are designed to provide a rigid connection between the connecting device 14″ and the head plate PT3 when the screws are put into place.

The connecting device 14″ is fitted with pin guides 121 that project downwards. To simplify the description, only one of these pin guides 121 is shown in FIG. 10. The lower faces of these pin guides 121 form stop surfaces that can bear on the upper face of the upper plate PS of the upper end piece ES3 of the assembly.

A single control device 120 is supported free to rotate at the centre of the connecting device 14″, while being fixed in place on the said device parallel to its axis 22″. The single control device 120 is provided with a manoeuvring head 122 that can be activated with an appropriate tool, at its upper end.

In the lower part, below the connecting device 14″, the single control device 120 comprises a thread 124 on which a nut 126 is engaged. The said nut 126 is fixed in rotation with respect to the connecting device 14″, such that rotation of the single control device 120 has the effect of controlling an upwards or downwards displacement of the nut 126 parallel to the axis 22″.

Four claws 128 are articulated on the nut 126 through their upper ends. This articulation is achieved by pivot axes 130 oriented along directions orthogonal to the axis 22″ of the connecting device 14″. More precisely, the pivot axes of the claws 128 are all arranged in the same plane perpendicular to the axis 22″, at an equal distance from it. Furthermore, the pivot axes 130 of the claws 128 arranged on each side of the longitudinal axis 22″ are parallel to each other and orthogonal to the pivot axes 130 of the other two claws 128.

Each of the claws 128 has a bent part 140 at its lower end, that projects outwards at approximately a right angle. Two claws 128 adjacent to each other are provided with thrust rollers 142 above the bent part 140. More precisely, these rollers 142 are used with the claws 128 to come into contact with the inner faces of the parts of the hollowed upper plate PS that will be applied in contact with the faces of the housing L3 designed to face downwards during subsequent transport of the packaging in the horizontal position.

The upper end of each of the claws 128 also includes a lug 132 above a thrust rod 134 fixed to the connecting device 14″, on its side facing the longitudinal axis 22″. A torsion spring 136 is wound around each of the pivot axes 130 and bears firstly on a rod 138 fixed to the nut 126 and secondly on the corresponding claw 128, so as to apply a lateral force on the end piece.

The lugs 132 of claws 128 without rollers 142 (see below) are terminated by a stop 133 designed to bear in contact with a surface 127 of the nut 126 when the bent parts 140 of the claws 128 are placed under the upper plate PS of the upper end piece ES3. This thus limits outwards rotation of each of the two claws not provided with rollers, so that these claws cannot apply any lateral force on the upper plate PS. The lateral displacement of the upper end piece ES3 towards the two required faces of the housing L can thus be assured by the two claws 128 provided with rollers 142, under the action of lateral forces applied on the said end piece by the springs 136.

In this third embodiment of the invention, the single control device 120 controls pivoting of the claws 128 that form firstly clamping means for the connecting device 14″ on the upper end piece ES3 of the assembly and axial displacement means of the assembly along the longitudinal axis 22″. Springs 136 also form means of transverse displacement of the upper end piece ES3 towards the corner of housing L3 that will face downwards during transport of the packaging in the horizontal position.

Thus, actuation of the single control device 120 from the retracted position illustrated in FIG. 12, will have the effect of separating the claws 128, by moving them upwards along axis 22″ and positioning the bent parts 140 under the upper plate PS. The two rollers 142 firstly come into contact with the corresponding inner faces of the recess in the upper plate PS of the upper end piece ES3. A transverse displacement of this end piece towards the above mentioned lower corner of the housing L3 is then obtained by the use of springs 136. The bent parts 140 of the claws 128 then bear in contact under the upper plate PS, which has the effect of raising the assembly in its housing. Finally, the upper plate PS is put into contact against the lower faces of the pin guides 121 fitted on the connecting device 14″, and which has the effect of fixing this device to the upper end piece ES3 of the assembly.

In the third embodiment of the invention illustrated in FIGS. 12 to 14, the attachment system 10″ is designed to be installed in the top of the housing L3 when the assembly A3 has already been inserted in it. Consequently, the lower end piece of the assembly bears on the shim C and on the bottom F of the packaging.

The operator brings the attachment system 10″ above the assembly A3. The attachment system is then in its retracted or unlocked position, in other words the nut 126 is in the low position relative to the single control device 120. Under these conditions, the bent parts 140 are retracted towards the axis 22″ and separated from the lower face of the recess formed in the upper plate PS.

The attachment system 10″ is inserted in the upper part of the housing L3 as shown in FIG. 12 and centred on the head plate PT3 using pins (not shown). The connecting device 14″ is then fixed to the head plate PT3, for example using screws 119.

The operator then activates the single control device 120 which has the effect of moving the nut 126 and the claws 128 upwards. The claws 128 progressively pivot outwards along their axes 130, so that the bent parts 140 can be positioned under the upper plate PS. The rollers 142 come into contact with the two corresponding faces of the recess formed in the upper plate PS through springs 136, which has the effect of bringing the-upper end piece ES3 into contact with the lower corner of the housing L3 mentioned above (FIG. 13).

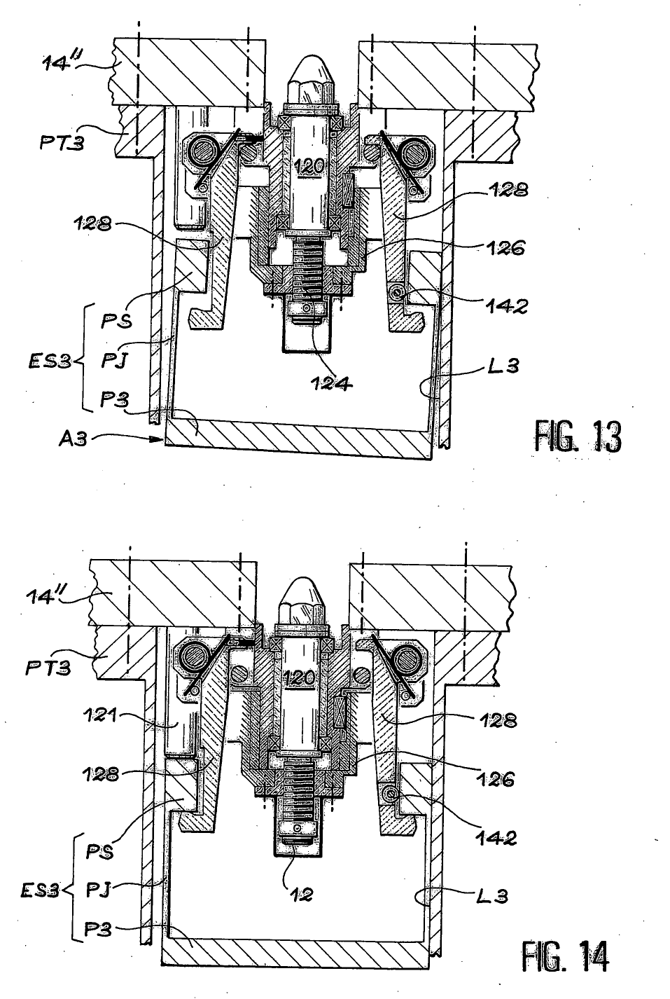

Continued activation of the control device 120 has the effect of lifting the assembly A3 and bringing the upper plate PS so that it bears in contact with the lower faces of the pin guides 121 supported by the connecting device 14″, as illustrated in FIG. 14.

When transport is terminated, the operator activates the single control device 120 in the opposite direction. This manoeuvre results in lowering the nut 126 and the claws 128. The claws are gradually released from the upper end piece ES3 of the assembly, which is then placed on the shims C (FIG. 1). The attachment system 10″ is removed when the claws 128 are sufficiently retracted.

The method and the device according to the invention thus produce a rigid connection between the upper end piece of the assembly and the open end of the housing, regardless of the type of assembly that is to be transported. This particularly simple arrangement is fairly small in the transverse direction, compared with blocking devices according to prior art.

Note that the invention is also applicable to blocking of a fuel assembly in any housing. Thus, as a non-limitative example, in particular this housing may belong to an assembly transport device, a pool storage basket or to a fuel assembly storage area in any installation.

1-20. (canceled)

21. A device for blocking a fuel assembly in a housing of a transport basket, the assembly comprising an upper end piece and the housing comprising a first open end and a second end, the device comprising:
means for making a rigid connection between the upper end piece of the fuel assembly and the open end of the housing, in a predetermined relative position such that the assembly bears in contact with at least one face of the housing on at least part of its length, the means for making a rigid connection being placed above the upper end piece of the assembly.

22. A device according to claim 21, in which the fuel assembly and the housing have polygonal sections and the predetermined relative position is such that the upper end piece is bearing in contact with the two adjacent faces of the housing.

23. A device according to claim 22, in which the fuel assembly and the housing have square sections.

24. A device according to claim 21, further comprising a part of the housing with a smaller section, located close to the second end of the housing, the part with a smaller section having dimensions approximately equal to dimensions of the lower end piece of the fuel assembly.

25. A device according to claim 21, in which the predetermined relative position is such that the fuel assembly is suspended by the upper end piece.

26. A device according to claim 21, in which the means for making a rigid connection comprises a connecting device configured to be fixed on the upper end piece of the assembly by first clamping means and that can be fixed in the open end of the housing by second clamping means.

27. A device according to claim 26, in which the connecting device includes means for transverse displacement configured to move the upper end piece of the assembly towards the two adjacent faces of the housing and away from them.

28. A device according to claim 27, in which the connecting device includes means for axial displacement configured to move the assembly away from the second end of the housing and towards the second end.

29. A device according to claim 28, in which the first clamping means, the second clamping means, the means for transverse displacement, and the means for axial displacement are activated by separate control devices configured to be maneuvered separately.

30. A device according to claim 29, in which the connecting device has a longitudinal axis configured to be oriented parallel to the longitudinal axis of the fuel assembly, and the first clamping means comprises jaws configured to move onto a first part of the connecting device along directions approximately radial with respect to the axis, the second clamping means comprises a bayonet ring configured to rotate about a second part of the connecting device about the axis, the means for axial displacement comprises means for controlling a relative displacement between the first part and the second part along the axis and the means for transverse displacement comprises at least one sliding block configured to move onto the first part of the connecting device along a direction approximately radial with respect to the axis, the sliding block also forming part of the second clamping means.

31. A device according to claim 28, in which the first clamping means, the second clamping means, and the means for axial displacement are activated by a single control device and the means for transverse displacement is activated by another control device configured to be maneuvered separately from the single control device.

32. A device according to claim 31, in which the single control device is a screw, anchored free to rotate on the connecting device, the screw acting on thrust rods forming the first clamping means and the means for axial displacement, and acting on jaws forming the second clamping means, through control rods articulated on the connecting device, on a nut engaged on the screw, on the thrust rods and the jaws, and the means for transverse displacement comprises thrust pads anchored on the connecting device.

33. A device according to claim 28, in which the first clamping means, the means for transverse displacement, and the means for axial displacement are activated by a single control device and the second clamping means comprises a separate attachment device.

34. A device according to claim 23, in which the single control device is a screw, anchored free to rotate on the connecting device, the screw acting on claws forming the first clamping means, the means for axial displacement, and the means for transverse displacement, through a nut engaged on the screw and on which the claws are articulated.

35. A method for blocking a fuel assembly in a housing of a transport basket, the assembly comprising an upper end piece and the housing comprising a first open end and a second end, the method comprising:
making a rigid connection between the upper end piece of the fuel assembly and the open end of the housing above the upper end piece of the assembly, in a predetermined relative position such that the fuel assembly is not in contact with the bottom of the housing and is either bearing in contact with at least one face of the housing or is bearing in contact with at least a part of the length of at least one face of the housing.

36. A method according to claim 35, in which a lower end piece of the fuel assembly is placed in a part of the housing with a smaller section, located close to the second end of the housing, so as to hold the lower end piece transversally in the housing.

37. A method according to claim 35, in which the fuel assembly and the housing have polygonal sections and the rigid connection is made in a predetermined relative position such that the upper end piece bears in contact with two adjacent faces of the housing.

38. A method according to claim 37, in which a connecting device is fixed on the upper end piece of the fuel assembly placed outside the housing, the fuel assembly is then inserted equipped with the connecting device in the housing oriented approximately vertically, the upper end piece is applied in contact with the two adjacent faces of the housing, and then the connecting device is fixed in the open end of the housing.

39. A method according to claim 37, in which a connecting device is inserted above the upper end piece of the fuel assembly, the fuel assembly being placed in the housing oriented approximately vertically, the assembly is lifted while fixing the connecting device in the open end of the housing, and then the upper end piece is applied in contact with the two adjacent faces of the housing.

40. A method according to claim 37, in which a connecting device is inserted above the upper end piece of the fuel assembly, the fuel assembly being placed in the housing oriented approximately vertically, the connecting device is fixed in the open end of the housing, the upper end piece is bring into contact with the two adjacent faces of the housing, and then the assembly is lifted and squeezed in contact with the connecting device in contact with the two adjacent faces of the housing.
